(19) United States
(12) Patent Application Publication
(10) Pub. No.: US 2015/0178607 A1
(43) Pub. Date: Jun. 25, 2015

(54) PRINTING CONTROL APPARATUS, PRINTING CONTROL SYSTEM, PRINTING CONTROL METHOD, AND NON-TRANSISTORY COMPUTER READABLE MEDIUM

(71) Applicant: FUJI XEROX CO., LTD., Tokyo (JP)

(72) Inventor: Kazunari TANAKA, Kanagawa (JP)

(73) Assignee: FUJI XEROX CO., LTD., Tokyo (JP)

(21) Appl. No.: 14/296,727

(22) Filed: Jun. 5, 2014

(30) Foreign Application Priority Data
Dec. 24, 2013 (JP) 2013-265094

(51) Int. Cl. G06K 15/00

(52) U.S. Cl. CPC G06K 15/408

(57) ABSTRACT

A printing control apparatus includes a reception unit that receives a print instruction to print on a recording medium, a transfer unit that causes the print instruction received to be stored on a memory while transferring the print instruction to a printer having a storage region configured to store a plurality of print instructions, an acquisition unit that acquires information related to a process state of the print instruction, transferred to the printer, from among the print instructions stored on the memory, a detector unit that detects an occurrence of a fault in the printer, and an identifying unit that identifies the print instruction with a printing operation thereof completed on the printer at detection of the occurrence of the fault by the detector unit, based on the information related to the process state acquired by the acquisition unit and the print instruction stored on the memory.

### CROSS-REFERENCE TO RELATED APPLICATIONS

This application is based on and claims priority under 35 USC 119 from Japanese Patent Application No. 2013-265094 filed Dec. 24, 2013.

### BACKGROUND

### Technical Field

The present invention relates to a printing control apparatus, a printing control system, a printing control method, and a non-transitory computer readable medium.

### SUMMARY

According to an aspect of the invention, a printing control apparatus is provided. The printing control apparatus includes a reception unit that receives a print instruction to print on a recording medium, a transfer unit that causes the print instruction received by the reception unit to be stored on a memory while transferring the print instruction to a printer having a storage region configured to store multiple print instructions, an acquisition unit that acquires information related to a process state of the print instruction, transferred to the printer, from among the print instructions stored on the memory, a detector unit that detects an occurrence of a fault in the printer, and an identifying unit that identifies the print instruction with a printing operation thereof completed on the printer at detection of the occurrence of the fault by the detector unit, based on the information related to the process state acquired by the acquisition unit and the print instruction stored on the memory.

### BRIEF DESCRIPTION OF THE DRAWINGS

Exemplary embodiments of the present invention will be described in detail based on the following figures, wherein:

FIG. 1 illustrates an example of a configuration of a printing control system of an exemplary embodiment;

FIG. 2 is a block diagram illustrating a functional configuration of a printing control apparatus of the exemplary embodiment;

FIG. 3 illustrates a hardware configuration of the printing control apparatus of the exemplary embodiment;

FIG. 4 illustrates a queue stored on a job memory;

FIG. 5 is a flowchart illustrating an example of a process in which one print job is stored in each queue;

FIG. 6A is a flowchart illustrating an example of a process to display information of an alarm;

FIG. 6B is a flowchart illustrating an example of the process to display the alarm information;

FIG. 6C is a flowchart illustrating an example of the process to display the alarm information;

FIG. 7 illustrates an example of a process of elements in the printing control system performed when a particular alarm is triggered; and

FIG. 8 illustrates an example of a process of the elements in the printing control system performed when a standard alarm is triggered.

### DETAILED DESCRIPTION

An exemplary embodiment of the present invention is described below with reference to the drawing.

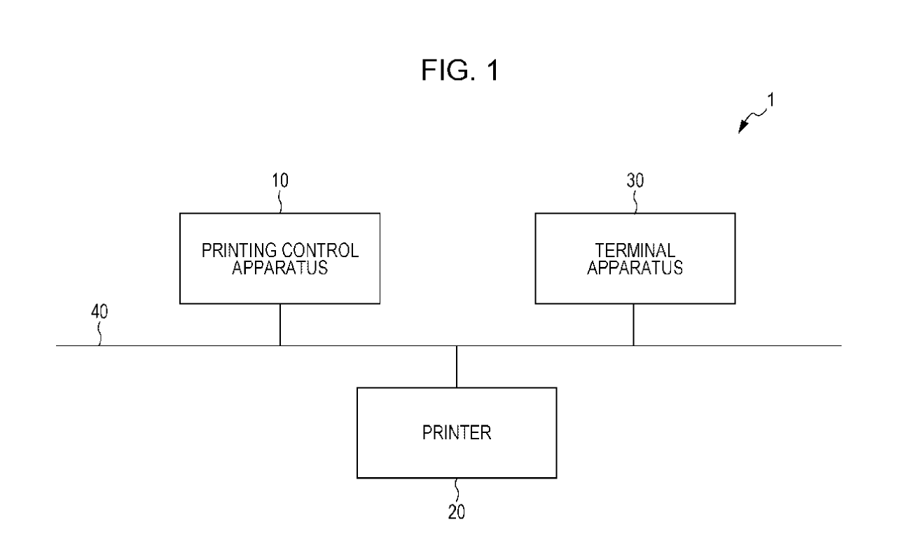

FIG. 1 illustrates an example of a configuration of a printing control system 1 of the exemplary embodiment. The printing control system 1 of the exemplary embodiment includes a printing control apparatus 10, a printer 20, and a terminal apparatus 30, each connected to a network 40.

The printing control apparatus 10 successively transfers print jobs transmitted from the terminal apparatus 30 to the printer 20, detects an alarm in the printer 20 if the alarm is triggered in the printer 20, and identifies a print job that is in progress on the printer 20 at the moment of the occurrence of the alarm. The operation of the printing control apparatus 10 is described more in detail below. The printing control apparatus 10 displays information of the identified print job and information of the alarm triggered in the printer 20. The printing control apparatus 10 thus notifies the user of the occurrence of the alarm in the middle of the print job. The print job includes data, such as an image and a document as a print target, and a control command in which setting in a print process is described. The print job is data serving as a unit of print process to be performed by the printer 20. In the exemplary embodiment, one example of a print instruction is the print job.

The printing control apparatus 10 acquires management information base (MIB) information from the printer 20 to detect the alarm and to identify the print job. Simple network management protocol (SNMP) is used as a protocol to monitor an apparatus. Such an apparatus publicly discloses the state thereof using the MIB information. In the exemplary embodiment, the MIB information includes information that indicates whether an alarm is triggered in the printer 20 and information indicating a process state of each print job held by the printer 20.

The printer 20 implements a scanning function, a print function, a copying function, and a facsimile function. The printer 20 performs a printing operation by forming an image on a recording medium based on a print job transferred from the printing control apparatus 10. The printer 20 has a spooling function. In the spooling function, the printer 20 temporarily stores the transferred print jobs on a memory therein, and outputs the print job in response to a progress state of printing to process the print job. In other words, the printer 20 may store multiple print jobs on the memory thereof. In response to a request from the printing control apparatus 10, the printer 20 transmits the MIB information to the printing control apparatus 10.

The user operates the terminal apparatus 30 to print data, such as an image or a document. The terminal apparatus 30 is a personal computer (PC), for example. In response to an operation of the user, the terminal apparatus 30 generates a print job, and then transmits the generated print job to the printing control apparatus 10.

A network 40 as an example of a communication line is used for information communications among the printing control apparatus 10, the printer 20, and the terminal apparatus 30. The network 40 is a local area network (LAN), for example. In the exemplary embodiment, the printing control apparatus 10, the printer 20, and the terminal apparatus 30 are connected to the network 40. A different configuration may also be acceptable. For example, a network connecting the printing control apparatus 10 and the printer 20 may be different from a network connecting the printing control apparatus 10 and the terminal apparatus 30.

In the printing control system 1, the print job is transmitted from the terminal apparatus 30 to the printer 20 via the printing control apparatus 10 instead of being directly transmitted to the printer 20.

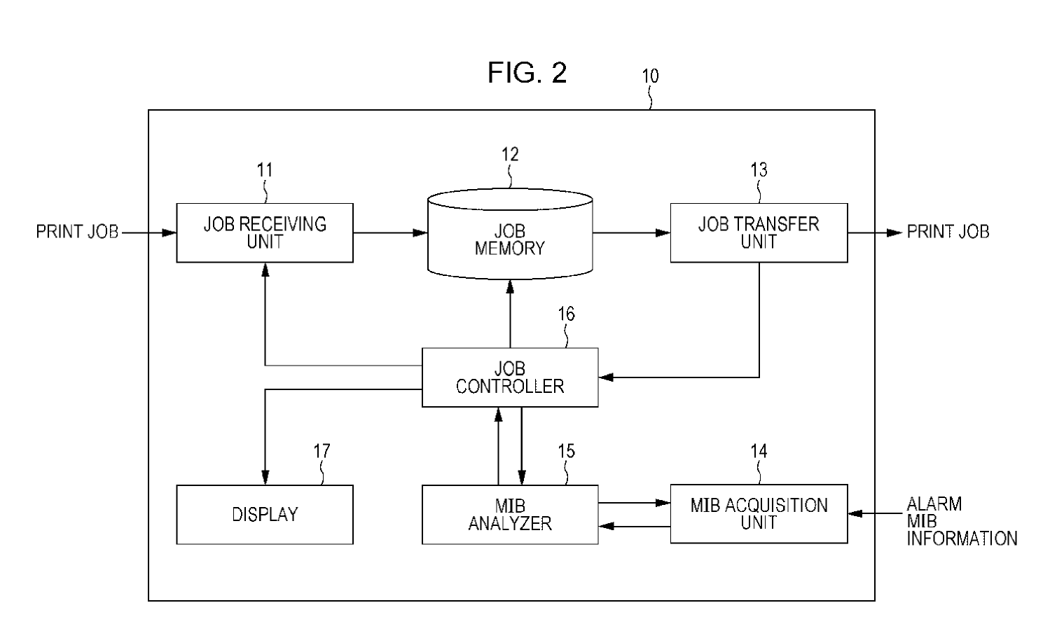

A functional configuration of the printing control apparatus 10 is described below. FIG. 2 is a block diagram illustrating the functional configuration of the printing control apparatus 10 of the exemplary embodiment.

The printing control apparatus 10 includes a job receiving unit 11 that receives a print job transmitted from the terminal apparatus 30, a job memory 12 that stores the print job, and a job transfer unit 13 that transfers the print job to the printer 20. The printing control apparatus 10 further includes an MIB acquisition unit 14, an MIB analyzer 15, a job controller 16, and a display 17. The MIB acquisition unit 14 acquires the MIB information from the printer 20. Based on the MIB information, the MIB analyzer 15 identifies the print job that is in progress when an alarm is triggered in the printer 20. The job controller 16 controls storage of the print job on the job memory 12, and displaying the information of the alarm triggered by the printer 20. The display 17 displays the information of the alarm triggered in the printer 20.

The job receiving unit 11 as an example of the reception unit receives a print job transmitted from the terminal apparatus 30.

The job memory 12 as an example of the memory stores the print job received by the job receiving unit 11. The job memory 12 includes four queues to store the print jobs. In accordance with a process state of the print job, the job memory 12 stores the print job on one of the four queues. The term queue refers to a storage region having a first-in first-out data structure. As the four queues, the job memory 12 includes a reservation queue, a transit queue as an example of a first region, an alarm monitoring queue as an example of a second region, and a complete print queue as an example of a third region.

The reservation queue is a region where the print job received by the job receiving unit 11 is stored first. The print job stored in the reservation queue moves to the transit queue when the print job is selected by the user. The number of print jobs the transit queue may store is fixed. If no space is available in the transit queue, the print job stored in the reservation queue is to wait on standby until a space is available in the transit queue. When the print job is transferred from the reservation queue to the transit queue, the print job identical to the print job transferred to the transit queue is also transferred to the printer 20. When the transfer of the print job to the printer 20 is complete, the print job stored in the transit queue moves to the alarm monitoring queue.

The print job identical to the print job having reached the alarm monitoring queue is stored on the printer 20, and is a target to be monitored. The print jobs transferred to the printer 20 are temporarily stored on the printer 20 and then successively performed. The print job that is determined to be completed by the printer 20 moves from the alarm monitoring queue to the complete print queue.

The job transfer unit 13 as an example of the transfer unit acquires the print job stored in the reservation queue of the job memory 12, and then transfers the acquires print job to the printer 20. The job transfer unit 13 having the spooling function stores the print job temporarily, and then successively transfers the print jobs to the printer 20. Upon completing the transfer of the print job to the printer 20, the job transfer unit 13 notifies the job controller 16 of the completion of the transfer of the print job.

The MIB acquisition unit 14 as the acquisition unit and the detector unit acquires periodically from the printer 20 the MIB information indicating the state of the printer 20 and determines whether an alarm is triggered by a fault in the printer 20. If an alarm is triggered, the MIB acquisition unit 14 outputs the information of the triggered alarm to the MIB analyzer 15. The alarms triggered in the printer 20 are divided into two types according to the level of alarm. For example, alarms triggered by paper jamming or paper-out may be immediately solved by the user. These alarms are ranked as a low-level alarm which may be solved within a standard operation practice. Alarms triggered by a toner-out or a hardware fault are a high-level alarm. These alarms ranked as a high-level alarm that may be difficult to clear within the standard operation practice, and may involve a special operation, such as calling in a service engineer, and possibly take time before recovery. In the following discussion, the low-level alarm is referred to as a standard alarm, and the high-level alarm is referred to as a particular alarm.

When instructed to acquire from the MIB analyzer 15 the MIB information related to the print job, the MIB acquisition unit 14 requests the printer 20 to transmit the MIB information of the print job having a job ID notified by the MIB analyzer 15. The MIB acquisition unit 14 thus acquires the MIB information from the printer 20. The job ID is a symbol that the job controller 16 attaches to the print job to identify the print job. For example, the job ID is a number that indicates an order at which the job receiving unit 11 has received the print job. The MIB acquisition unit 14 then outputs the acquired MIB information to the MIB analyzer 15.

Upon receiving from the MIB acquisition unit 14 the information of the alarm triggered in the printer 20, the MIB analyzer 15 as an example of the identifying unit determines whether the alarm is a particular alarm or not. If the alarm is a particular alarm, the MIB analyzer 15 outputs the information of the triggered particular alarm to the job controller 16. If the alarm is not a particular alarm, the triggered alarm is a standard alarm. The MIB analyzer 15 acquires from the job controller 16 a list registering the job ID of the print job stored in the alarm monitoring queue (hereinafter referred to as a monitoring list). The MIB analyzer 15 then instructs the MIB acquisition unit 14 to acquire the MIB information related to the print job having the job ID registered in the monitoring list.

Based on the MIB information acquired from the MIB acquisition unit 14, the MIB analyzer 15 identifies from among the print jobs indicated by the monitoring list the print job that is determined to be in progress on the printer 20. The MIB analyzer 15 outputs to the job controller 16 the job ID of the identified print job and the information of the standard alarm triggered in the printer 20. If there is a print job whose corresponding MIB information is difficult to acquire in the monitoring list, the MIB analyzer 15 notifies the job controller 16 of that print job ID.

The job controller 16 as an example of the transfer unit and the movement control unit performs the following operations to store the print job on each queue of the job memory 12.

When the job receiving unit 11 receives a print job, the job controller 16 attaches a job ID to the received print job, and stores the print job on the reservation queue of the job memory 12. The job controller 16 successively moves the print jobs stored in the reservation queue to the transit queue, while generating a print job identical to the print job to be moved, and then outputs the generated print job to the job transfer unit 13. The print job to be output to the job transfer unit 13 has the same job ID as the one attached to the print job to be moved to the transit queue.

Upon receiving from the job transfer unit 13 a notification that the transfer of the print job to the printer 20 is complete, the job controller 16 moves the print job identical to the transferred print job from the transit queue to the alarm monitoring queue. The movement of the print job to the alarm monitoring queue creates a space in the transit queue. If a print job in the reservation queue is selected by the user, the job controller 16 moves the print job in the reservation queue to the transit queue.

Upon receiving from the MIB analyzer 15 the job ID of the print job whose MIB information is difficult to acquire, the job controller 16 determines that the printer 20 has completed that print job and does not hold that print job. The job controller 16 moves the print job having the same job ID as the acquired job ID from the alarm monitoring queue to the complete print queue.

The job controller 16 as an example of a display control unit displays the alarm triggered in the printer 20.

The job controller 16 generates the monitoring list in response to a request from the MIB analyzer 15, and outputs the generated monitoring list to the MIB analyzer 15. The job controller 16 receives from the MIB analyzer 15 the job ID of the print job determined to be in progress on the printer 20 and the information of the standard alarm triggered in the printer 20. The job controller 16 then generates information to notify the occurrence of the standard alarm (hereinafter referred to as standard alarm notification information). The standard alarm notification information is used to notify the user that the standard alarm is triggered in the printer 20 during the execution of the print job having the identified job ID. Upon generating the standard alarm notification information, the job controller 16 causes the display 17 to display the generated standard alarm notification information.

Upon acquiring from the MIB analyzer 15 the information of the particular alarm triggered in the printer 20, the job controller 16 generates information to notify the user that the particular alarm has been triggered in the printer 20 (hereinafter referred to as particular alarm notification information). Upon generating the particular alarm notification information, the job controller 16 causes the display 17 to display the generated particular alarm notification information.

In response to a control signal transmitted from the job controller 16, the display 17 displays the standard alarm notification information or the particular alarm notification information.

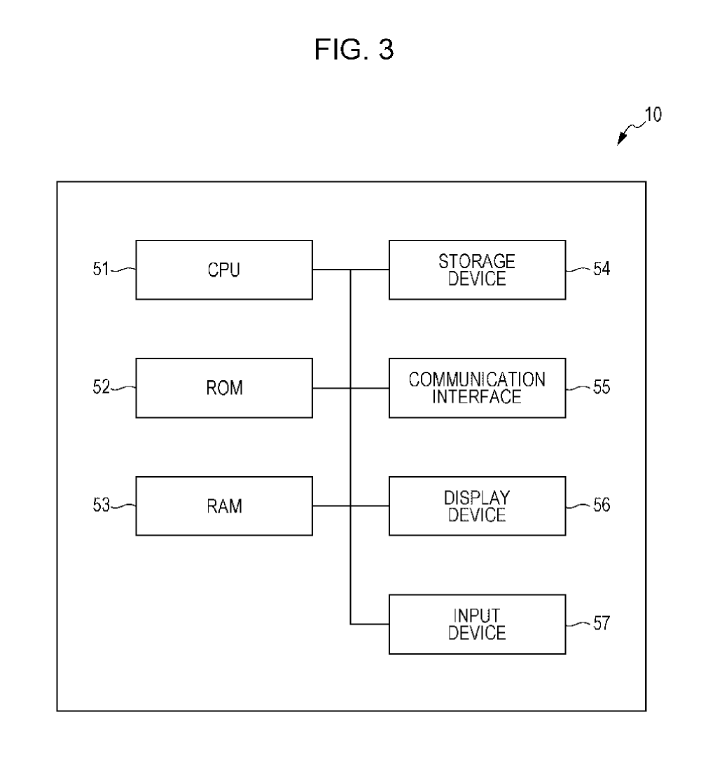

A hardware configuration of the printing control apparatus 10 is described below. FIG. 3 illustrates the hardware configuration of the printer 10 of the exemplary embodiment. As illustrated in FIG. 3, the printing control apparatus 10 includes a central processing unit (CPU) 51 as a processor, and as a memory, a read-only memory (ROM) 52, a random-access memory (RAM) 53, and a storage device 54.

The ROM 52 stores a variety of programs, and the RAM 53 serves as a working area used when the CPU 51 executes the variety of programs. The storage device 54 stores input data and output data in each of the programs. The ROM 52 stores a program to implement each function of the printing control apparatus 10 of FIG. 2. The program is loaded on the RAM 53, and the CPU 51 executes a process responsive to the program. Each function of the printing control apparatus 10 is thus implemented. The printing control apparatus 10 includes a communication interface 55 to communicate with outside, a display device 56, such as a liquid-crystal display, or an organic electroluminescence (EL) display, and an input device 57, such as a keyboard and a mouse.

The functions of the job receiving unit 11, the job transfer unit 13, the MIB acquisition unit 14, the MIB analyzer 15, and the job controller 16 are implemented when the CPU 51 executes the program on the printing control apparatus 10. The reception of the print job through the job receiving unit 11, the transfer of the print job through the job transfer unit 13, and the acquisition of the MIB information through the MIB acquisition unit 14 are performed via the communication interface 55. The job memory 12 is implemented by the storage device 54. The display 17 is implemented by the display device 56.

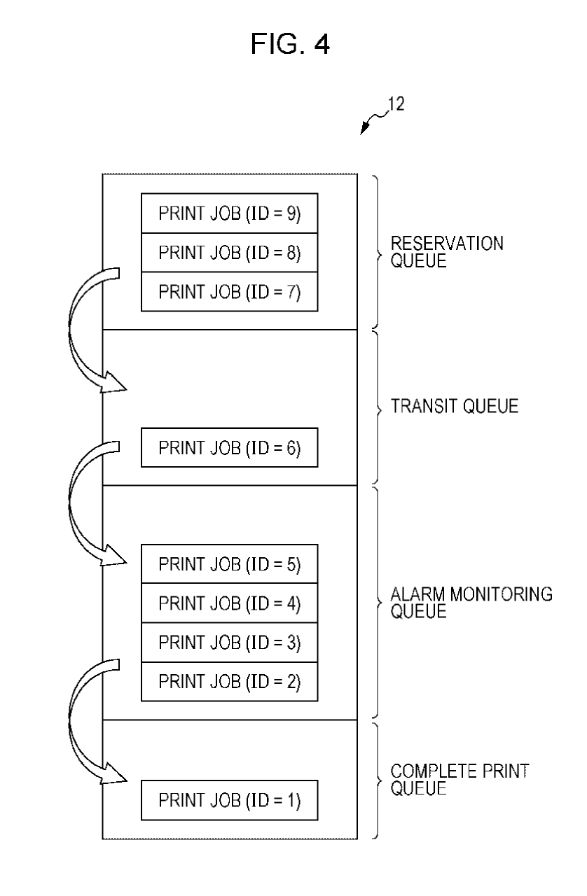

The queues of the job memory 12 are described below. FIG. 4 illustrates the queue held on the job memory 12. As described above, the job memory 12 includes the reservation queue, the transit queue, the alarm monitoring queue, and the complete print queue.

The print job received by the job receiving unit 11 is tagged with the job ID and then stored in the reservation queue. Three print jobs identified by job IDs 7 through 9 are stored in the reservation queue of FIG. 4. The print jobs stored in the reservation queue are successively moved to the transit queue, and identical print jobs thereof are also transferred to the printer 20. The print job having a job ID 6 is stored in the transit queue of FIG. 4. The job transfer unit 13 transfers to the printer 20 another print job having the job ID 6 (not illustrated).

When the job transfer unit 13 completes the transfer of the print job to the printer 20, the print job identical to the transferred print job is moved to the alarm monitoring queue. Four print jobs respectively having job IDs 2 through 5 are stored in the alarm monitoring queue of FIG. 4. The printer 20 holds also identical print jobs having job IDs 2 through 5, and successively performs printing operations corresponding thereto. The job IDs of these four print jobs are registered as monitoring targets in the monitoring list.

The print job that is determined to be complete on the printer 20 moves from the alarm monitoring queue to the complete print queue. The print job having a job ID 1 is stored in the complete print queue of FIG. 4, and is thus determined to be complete.

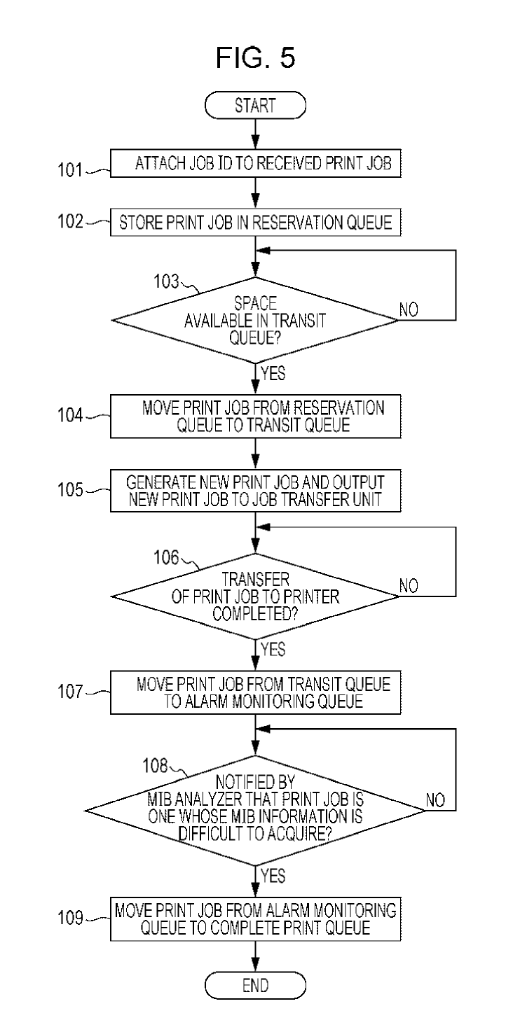

The process of the job controller 16 to store the print job on each queue of the job memory 12 is described below. FIG. 5 is a flowchart illustrating an example of the process in which one print job is sequentially stored in the queues.

When the job receiving unit 11 receives a print job transmitted from the terminal apparatus 30, the job controller 16 attaches a job ID to the received print job (step 101). For example, the job controller 16 attaches a job ID “1” to the received print job. The job controller 16 stores the print job (job ID=1) to the reservation queue (step 102).

If the print job (job ID=1) is selected by the user, the job controller 16 determines whether a space is available in the transit queue (step 103). If a space is available (yes branch from step 103), the job controller 16 moves the print job (job ID=1) from the reservation queue to the transit queue (step 104). If no space is available (no branch from step 103), the job controller 16 waits on standby until a space is available in the transit queue. If there is a print job stored in the reservation queue prior to the print job (job ID=1), the job controller 16 moves the previously stored print job first to the transit queue. Upon moving the print job (job ID=1) to the transit queue, the job controller 16 generates a new print job (job ID=1) and then outputs the new job to the job transfer unit 13 (step 105). The job transfer unit 13 transfers the print job to the printer 20.

The job controller 16 determines whether the print job (job ID=1) has been transferred to the printer 20 (step 106). If a notification of the completion of the print job transfer has not been received from the job transfer unit 13, the job controller 16 determines that the print job transfer has not been complete (no branch from step 106), and waits on standby until the notification has been received. If the notification of the completion of the print job transfer has been received, the job controller 16 determines that the print job transfer has been complete (yes branch from step 106). The job controller 16 moves the print job (job ID=1) from the transit queue to the alarm monitoring queue (step 107).

The job controller 16 determines whether the job controller 16 is notified by the MIB analyzer 15 that the print job (job =1) is a print job whose MIB information is difficult to acquire (step 108). If the job controller 16 is not notified that the print job (job ID=1) is a print job whose MIB information is difficult to acquire (no branch from step 108), the job controller 16 waits on standby until the notification. If the job controller 16 is notified that the print job (job ID=1) is a print job whose MIB information is difficult to acquire (yes branch from step 108), the job controller 16 moves the print job (job ID=1) from the alarm monitoring queue to the complete print queue (step 109). The process thus ends.

The job controller 16 thus successively stores the print job transmitted from the terminal apparatus 30 on each of the queues of the job memory 12 one after another in this way.

In the process of FIG. 5, the job controller 16 stores the print job in each queue. The operations of the job controller 16 to store the print jobs on the queues are performed in parallel. For example, the job controller 16 moves the print job (job ID=1) from the alarm monitoring queue while moving a print job (job ID=2) stored in the reservation queue subsequent to the print job (job ID=1) to the transit queue in parallel. More specifically, four operations in step 101 and 102, step 103 through 105, step 106 and 107, and step 108 and 109 are performed in parallel. Operations responsive to each print job transmitted from the terminal apparatus 30 are thus performed.

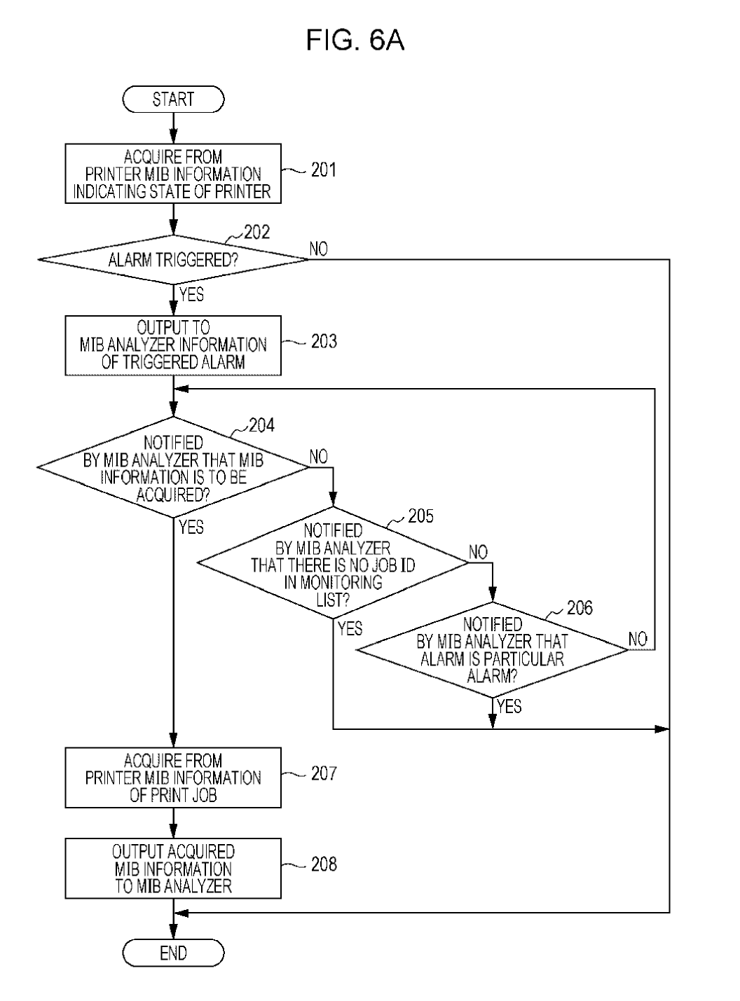

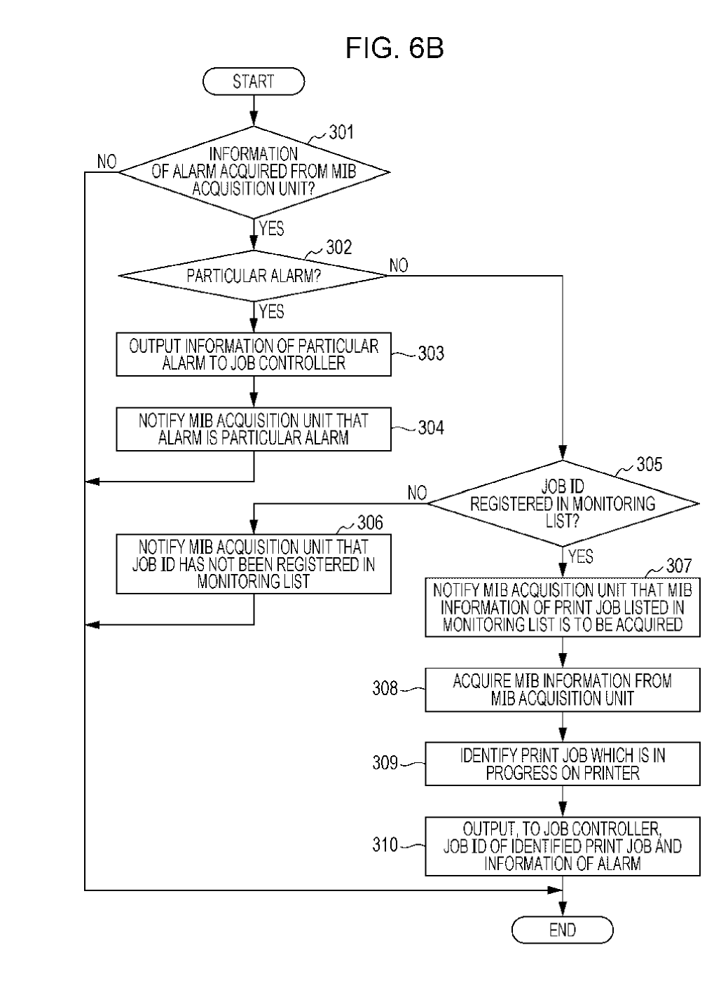

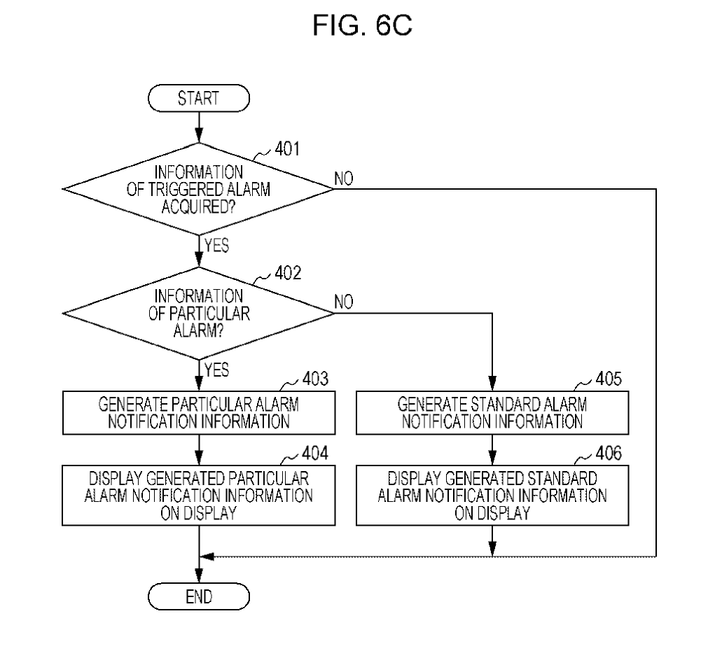

A display process to display the information of the alarm triggered in the printer 20 is described below. FIG. 6A through FIG. 6C are flowcharts illustrating processes to display the information of the alarm. FIG. 6A is the flowchart illustrating an example of the process of the MIB acquisition unit 14. FIG. 6B is the flowchart illustrating an example of the process of the MIB analyzer 15. FIG. 6C is the flowchart illustrating an example of the process of the job controller 16.

The process of the MIB acquisition unit 14 illustrated in FIG. 16A is described below. The process of FIG. 16A is periodically performed by the MIB acquisition unit 14.

The MIB acquisition unit 14 acquires from the printer 20 the MIB information indicating the state of the printer 20 (step 201). In accordance with the acquired MIB information, the MIB acquisition unit 14 determines whether an alarm is triggered in the printer 20 (step 202). If no alarm is triggered (no branch from step 202), the process is complete. If an alarm is triggered (yes branch from step 202), the MIB acquisition unit 14 outputs the information of the triggered alarm to the MIB analyzer 15 (step 203).

The MIB acquisition unit 14 determines whether the MIB acquisition unit 14 is notified by the MIB analyzer 15 that the MIB information related to the print job is to be acquired (step 204). If the MIB acquisition unit 14 is not notified that the MIB information is to be acquired (no branch from step 204), the MIB acquisition unit 14 then determines whether the MIB acquisition unit 14 is notified by the MIB analyzer 15 that no job ID is found in the monitoring list (step 205). If the MIB acquisition unit 14 is notified that no job ID is found (yes branch from step 205), there is no print job as a monitoring target. The process is thus complete.

If the MIB acquisition unit 14 is not notified that no job ID is found (no branch from step 205), the MIB acquisition unit 14 further determines whether the MIB acquisition unit 14 is notified by the MIB analyzer 15 that the alarm is a particular alarm (step 206). If the MIB acquisition unit 14 is notified that the alarm is a particular alarm (yes branch from step 206), the MIB acquisition unit 14 ends the process without retrieving the MIB information of the print job from the printer 20. If the MIB acquisition unit 14 is not notified that the alarm is a particular alarm (no branch from step 206), the MIB acquisition unit 14 waits on standby until a notification is received in one of the steps 204 through 206.

If the MIB acquisition unit 14 is notified in step 204 that the MIB information related to the print job is to be acquired (yes branch from step 204), the MIB acquisition unit 14 specifies the print job having the job ID in the notified monitoring list and acquires from the printer 20 the MIB information of the specified print job (step 207). The MIB acquisition unit 14 then outputs the acquired MIB information to the MIB analyzer 15 (step 208). The process is thus complete.

The process of FIG. 6B is described below.

The MIB analyzer 15 determines whether the MIB acquisition unit 14 has acquired the information of the alarm triggered in the printer 20 (step 301). If an alarm is triggered in the printer 20, the MIB analyzer 15 acquires the information of the alarm from the MIB acquisition unit 14 in step 203. If no information of alarm is acquired (no branch from step 301), the process is thus complete.

Upon acquiring the information of the alarm (yes branch from step 301), the MIB analyzer 15 determines whether the alarm is a particular alarm (step 302). If the alarm is a particular alarm (yes branch from step 302), the MIB analyzer 15 outputs the information of the triggered particular alarm to the job controller 16 (step 303). The MIB analyzer 15 notifies the MIB acquisition unit 14 that the alarm is the particular alarm (step 304). The process is thus complete. The MIB acquisition unit 14, after being notified of the particular alarm, performs a process following the yes branch in step 206.

If the alarm is not a particular alarm (no branch from step 302), the alarm is a standard alarm. The MIB analyzer 15 acquires the monitoring list from the job controller 16, and determines whether the job ID is registered in the acquired monitoring list (step 305). If the job ID is not registered in the monitoring list (no branch from step 305), the MIB analyzer 15 notifies the MIB acquisition unit 14 that the job ID has not been registered in the monitoring list (step 306). The process is thus complete. Subsequent to the notification, the MIB acquisition unit 14 performs a process following the yes branch in step 205.

If the job ID is registered in the monitoring list (yes branch from step 305), the MIB analyzer 15 instructs the MIB acquisition unit 14 to acquire the MIB information of the print job listed in the monitoring list (step 307). The MIB acquisition unit 14 performs a process following the yes branch in step 204. The MIB analyzer 15 acquires the MIB information from the MIB acquisition unit 14 (step 308), and identifies the print job that is determined to be in progress on the printer 20 based on the acquired MIB information (step 309). For example, the MIB information contains as a process state of each print job “processing” indicative of a print operation in progress, or “waiting” indicative of waiting for a print operation. The MIB analyzer 15 identifies a print job having a process state “processing” to be a print job in progress. The MIB analyzer 15 then outputs the job ID of the identified print job and the standard alarm notification information obtained in step 301 to the job controller 16 (step 310). The process is thus complete.

The process of FIG. 6C is described below.

The job controller 16 determines whether the information of the alarm triggered in the printer 20 has been acquired from the MIB analyzer 15 (step 401). The yes branch is followed if the MIB analyzer 15 outputs the information of the particular alarm in step 303 or if the MIB analyzer 15 outputs the information of the standard alarm in step 310. If the information of the alarm is not acquired (no branch from step 401), the process is complete.

Upon receiving the information of the alarm (yes branch from step 401), the job controller 16 determines whether the information is the information of the particular alarm (step 402). If the information is that of the particular alarm (yes branch from step 402), the job controller 16 generates the particular alarm notification information based on the information of the particular alarm (step 403). The job controller 16 causes the display 17 to display the generated particular alarm notification information (step 404). The process is thus complete.

If the information is not that of the particular alarm (no branch from step 402), the alarm is a standard alarm. The job controller 16 generates the standard alarm notification information based on the acquired information of the standard alarm and the job ID of the print job that is determined to be in progress (step 405). The job controller 16 causes the display 17 to display the generated standard alarm notification information (step 406). The process is thus complete.

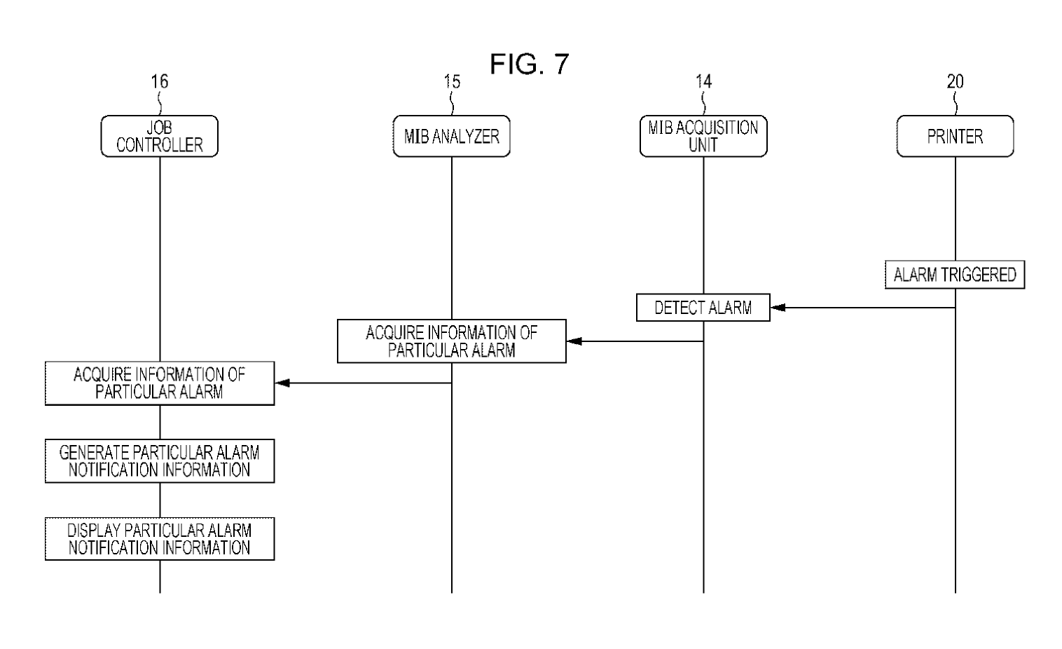

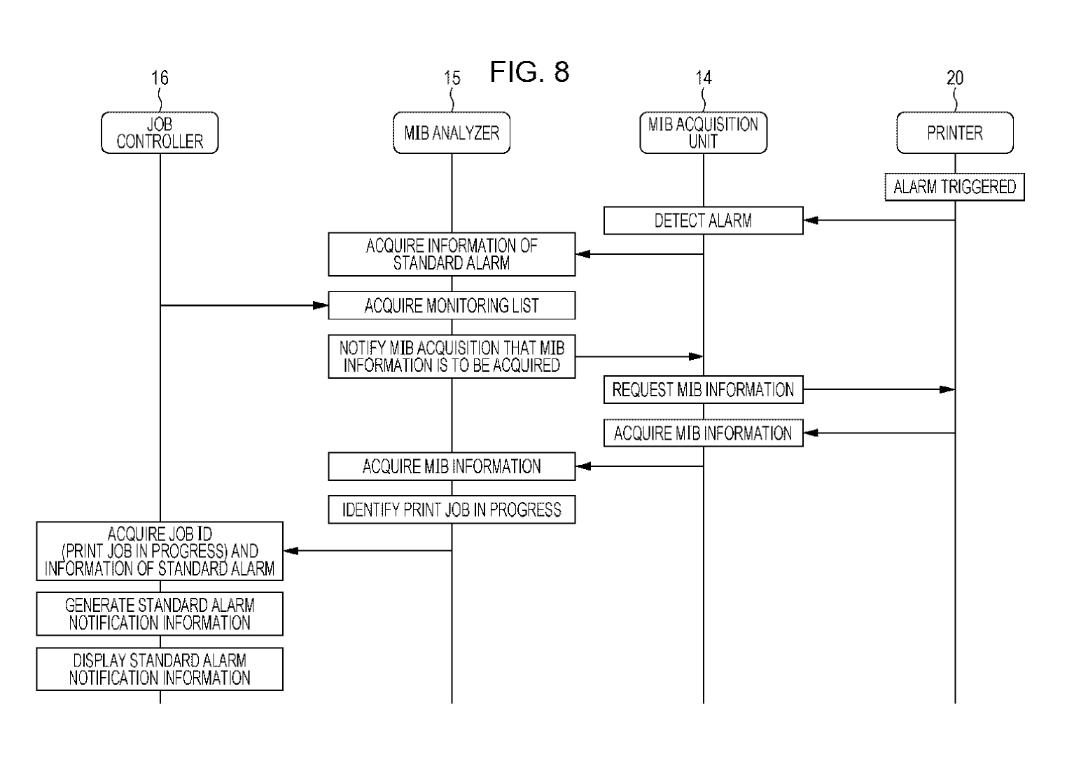

A process performed among elements to display the information of the alarm triggered in the printer 20 is described below. FIG. 7 illustrates an example of the process of elements in the printing control system performed when the particular alarm is triggered. FIG. 8 illustrates an example of the process of the elements in the printing control system performed when the standard alarm is triggered. The process performed among the elements, for example, among the MIB acquisition unit 14, the MIB analyzer 15, and the job controller 16 is described. The process performed by the printer 20 in association with the elements is also described. Steps described below correspond to steps illustrated in FIG. 6.

The process of FIG. 7 is described.

The MIB acquisition unit 14 acquires the MIB information indicative of the state of the printer 20. If an alarm is triggered in the printer 20, the MIB acquisition unit 14 detects the triggered alarm (steps 201 and 202). The MIB acquisition unit 14 outputs the information of the triggered alarm to the MIB analyzer 15 (step 203).

The MIB analyzer 15 acquires the information of the alarm, determines that the alarm is a particular alarm, and outputs the information of the particular alarm to the job controller 16 (steps 301 through 303). Upon acquiring the information of the particular alarm, the job controller 16 generates the particular alarm notification information and causes the display 17 to display the generated particular alarm notification information (steps 401 through 404). When the particular alarm is triggered in the printer 20 in this way, the user is notified of the information of the particular alarm.

The process of FIG. 8 is described below.

Upon detecting the alarm triggered in the printer 20 (steps 201 and 202), the MIB acquisition unit 14 outputs the information of the triggered alarm to the MIB analyzer 15 (step 203).

Upon acquiring the information of the alarm, the MIB analyzer 15 may determine that the alarm is a standard alarm. The MIB analyzer 15 acquires the monitoring list from the job controller 16 and determines whether the job ID is registered in the acquired monitoring list (steps 301, 302, and 305). Based on the assumption that the job ID is registered in the monitoring list in the process of FIG. 8, the MIB analyzer 15 instructs the MIB acquisition unit 14 to acquire the MIB information of the print job listed in the monitoring list (step 307).

The MIB acquisition unit 14 requests the printer 20 to send the MIB information of the print job having the notified job ID and then acquires the MIB information (steps 204 and 207). The MIB acquisition unit 14 may then request the MIB information on a per print job basis or may request the MIB information of all the print jobs collectively. Upon acquiring the MIB information, the MIB acquisition unit 14 outputs the acquired MIB information to the MIB analyzer 15 (step 208).

Upon acquiring the MIB information, the MIB analyzer 15 identifies the print job that is determined to be in progress on the printer 20, based on the acquired MIB information (steps 308 and 309). The MIB analyzer 15 outputs to the job controller 16 the job ID of the identified print job and the information of the standard alarm (step 310).

The job controller 16 receives the job ID of the identified print job and the information of the standard alarm (steps 401 and 402), generates the standard alarm notification information, and causes the display 17 to display the generated standard alarm notification information (steps 405 and 406). If the standard alarm is triggered in the printer 20 in this way, the user is notified of the information of the standard alarm in association with the print job that is in progress at the moment when the standard alarm is triggered.

As described above, the printing control apparatus 10 transfers the print job transmitted from the terminal apparatus 30 to the printer 20 and continuously stores the print job after being transferred to the printer 20. The printing control apparatus 10 detects the alarm triggered in the printer 20, acquires the MIB information from the printer 20, identifies the print job that is in progress on the printer 20, namely, the print job that is undergoing an image forming process on a paper sheet when the alarm is triggered, and notifies the user of the identified print job.

An apparatus of one type may exclude from a management target a print job once transferred to the printer 20 and may not acquire a process state of that print job. In comparison with such an apparatus, the printing control apparatus 10 easily identifies the print job that is in progress when the alarm is triggered in the printer 20 even if the printer 20 has a spooling function having multiple print jobs in assignment. If the high-level alarm that is difficult to clear within the normal operation practice is triggered in the printer 20, the printing control apparatus 10 notifies the user of the particular alarm by displaying the information of the particular alarm regardless of whether the print job is stored on the job memory 12.

In the exemplary embodiment, if the job controller 16 is notified by the MIB analyzer 15 of the job ID of the print job whose MIB information is difficult to acquire, the job controller 16 determines that the print job is complete on the printer 20. The present invention is not limited to this arrangement. For example, if the print job is stored in the alarm monitoring queue for a predetermined period or longer, the job controller 16 may determine that the print job is complete on the printer 20. Alternatively, the printer 20 may notify the printing control apparatus 10 of the print job that is complete.

In the exemplary embodiment, the job memory 12 stores the print job. The job memory 12 may store part of the print job, such as a control command, instead of storing all the print job.

In the exemplary embodiment, the MIB acquisition unit 14 specifies the print job having the job ID in the monitoring list and acquires from the printer 20 the MIB information of the specified print job. The present invention is not limited to this arrangement. For example, the MIB acquisition unit 14 may acquire the MIB information of a print job held by the printer 20, specify a print job having a job ID in the monitoring list in accordance with the acquired MIB information, and then acquire the MIB information of the specified print job.

In the exemplary embodiment, the printing control system 1 includes a single printer 20 and a single terminal apparatus 30. Alternatively, the printing control system 1 may include multiple printers 20 and multiple terminal apparatuses 30. If multiple printers 20 are used, the terminal apparatus 30 may transmit the print job to the printing control apparatus 10 while specifying a printer 20 that serves as a transmission destination of the print job. The queues of the job memory 12 are present on each printer 20, and the monitoring list is generated on each printer 20.

The process performed by the printing control apparatus 10 in the exemplary embodiment may be implemented in a program, such as an application software product.

The process performed by the printing control apparatus 10 may be interpreted as a program causing a computer to implement the functions of receiving a print instruction to print on a recording medium, causing the received print instruction to be stored on a memory while transferring the print instruction to a printer having a storage region configured to store multiple print instructions, acquiring information related to a process state of the print instruction, transferred to the printer, from among the print instructions stored on the memory, detecting an occurrence of a fault in the printer, and identifying the print instruction with a printing operation thereof completed on the printer at detection of the occurrence of the fault, based on the information related to the acquired process state and the print instruction stored on the memory.

The program implementing the exemplary embodiment of the present invention may be provided via a communication medium, or in a recorded form on a recording medium, such as a compact disk ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A printing control apparatus comprising:
a reception unit configured to receive a print instruction to print on a recording medium;
a transfer unit configured to cause the print instruction received by the reception unit to be stored in a memory configured to store a plurality of print instructions and configured to transfer the print instruction to a printer;
an acquisition unit configured to acquire information related to a process state of the print instruction, transferred to the printer, from among the print instructions stored in the memory;
a detector unit configured to detect an occurrence of a fault in the printer; and
an identifying unit configured to identify, based on the information related to the process state acquired by the acquisition unit and the print instruction stored in the memory, the print instruction with a printing operation thereof completed on the printer in response to detection of the occurrence of the fault by the detector unit.

2. The printing control apparatus according to claim 1, further comprising:
a movement control unit configured to control a movement of the print instruction from a first region of the memory to a second region of the memory in response to the transfer unit completing the transfer of the print instruction to the printer,
wherein the acquisition unit is configured to specify the print instruction stored in the second region in order to acquire the information related to the process state of the specified print instruction.

3. The printing control apparatus according to claim 2, wherein the movement control unit is configured to control a movement of the print instruction stored in the second region to a third region of the memory based on a determination that (i) information related to the process state of the print instruction stored in the second region is not present on the printer or (ii) a storage time duration of the print instruction in the second region exceeds a predetermined time.

4. The printing control apparatus according to claim 7, further comprising:
a display control unit configured to control (i) displaying of, in an associated form, information related to the fault detected by the detector unit and information related to the print instruction identified by the identifying unit in response to the determining unit determining that the fault detected by the detector unit is not the predetermined fault and (ii) displaying of the information related to the fault detected by the detector unit in response to the determining unit determining that the fault detected by the detector unit is the predetermined fault.

5. The printing control apparatus according to claim 8, further comprising:
a display control unit configured to control (i) displaying of, in an associated form, information related to the fault detected by the detector unit and information related to the print instruction identified by the identifying unit in response to the determining unit determining that the fault detected by the detector unit is not the predetermined fault and (ii) displaying of the information related to the fault detected by the detector unit in response to the determining unit determining that the fault detected by the detector unit is the predetermined fault.

6. The printing control apparatus according to claim 9, further comprising:
a display control unit configured to control (i) displaying of, in an associated form, information related to the fault detected by the detector unit and information related to the print instruction identified by the identifying unit in response to the determining unit determining that the fault detected by the detector unit is not the predetermined fault and (ii) displaying of the information related to the fault detected by the detector unit in response to the determining unit determining that the fault detected by the detector unit is the predetermined fault.

7. The printing control apparatus according to claim 1, further comprising:
a determining unit configured to determine whether the fault detected by the detector unit is a predetermined fault,
wherein the identifying unit does not identify the print instruction in response to the determining unit determining that the fault detected by the detector unit is a predetermined fault.

8. The printing control apparatus according to claim 2, further comprising:
a determining unit configured to determine whether the fault detected by the detector unit is a predetermined fault,
wherein the identifying unit does not identify the print instruction in response to the determining unit determining that the fault detected by the detector unit is a predetermined fault.

9. The printing control apparatus according to claim 3, further comprising:
a determining unit configured to determine whether the fault detected by the detector unit is a predetermined fault,
wherein the identifying unit does not identify the print instruction in response to the determining unit determining that the fault detected by the detector unit is a predetermined fault.

10. A printing control system comprising:
a printer that performs a printing operation in response to a print instruction to print on a recording medium; and
a printing control apparatus that is connected to the printer via a communication line,
wherein the printer includes a storage region configured to store a plurality of print instructions transmitted from the printing control apparatus; and
wherein the printing control apparatus includes:
a reception unit configured to receive the print instruction to print on the recording medium;
a transfer unit configured to cause the print instruction received by the reception unit to be stored in a memory configured to store a plurality of received print instructions and configured to transfer the print instruction to the printer;
an acquisition unit configured to acquire information related to a process state of the print instruction, transferred to the printer, from among the print instructions stored in the memory;
a detector unit configured to detect an occurrence of a fault in the printer; and
an identifying unit configured to identify, based on the information related to the process state acquired by the acquisition unit and the print instruction stored in the memory, the print instruction with a printing operation thereof completed on the printer in response to detection of the occurrence of the fault by the detector unit.

11. A printing control method comprising:
receiving a print instruction to print on a recording medium;
causing the received print instruction to be stored in a memory configured to store a plurality of print instructions and transferring the received print instruction to a printer;
acquiring information related to a process state of the print instruction, transferred to the printer, from among the print instructions stored in the memory;
detecting an occurrence of a fault in the printer; and
identifying, based on the acquired information related to the process state of the print instruction and the print instruction stored in the memory, the print instruction with a printing operation thereof completed on the printer in response to detection of the occurrence of the fault.

12. A non-transitory computer readable medium storing a program causing a computer to execute a process for controlling printing, the process comprising:
receiving a print instruction to print on a recording medium;
causing the received print instruction to be stored in a memory configured to store a plurality of print instructions and transferring the received print instruction to a printer;
acquiring information related to a process state of the print instruction, transferred to the printer, from among the print instructions stored in the memory;
detecting an occurrence of a fault in the printer; and
identifying, based on the acquired information related to the process state of the print instruction and the print instruction stored in the memory, the print instruction with a printing operation thereof completed on the printer in response to detection of the occurrence of the fault.
